(19) United States
(12) Patent Application Publication
(10) Pub. No.: US 2012/0196717 A1
(43) Pub. Date: Aug. 2, 2012

(54) FRICTION GEAR

(76) Inventor: Johannes Rieger, Semriach (AT)

(21) Appl. No.: 13/352,924

(22) Filed: Jan. 18, 2012

(30) Foreign Application Priority Data
Jan. 27, 2011 (AT) A 107/2011

(51) Int. Cl. F16H 37/02

(52) U.S. Cl. 475/214

(57) ABSTRACT

A friction gear for the continuously variable speed control of an output shaft driven by an input shaft, and which includes a gear or differential gear between first and second friction wheels, and a friction disk whose rotation axis extends perpendicularly to the rotation axes of the friction wheels and is displaceable in parallel to the rotation axis of the friction wheels. The friction disk includes a recess or depression concentrically positioned in relation to the rotational axis thereof.

The invention relates to a friction gear for the continuously variable speed control of the speed of an output shaft which is driven by a driving input shaft, with a planetary gear or differential gear being arranged between the input and output shaft, with a first component of the planetary or differential gear being connected with a first friction wheel and the second component of the planetary or differential gear being connected with a second friction wheel disposed on the same rotational axis, with the second friction wheel being drivingly connected with the output shaft and with the input shaft being drivingly connected with a third component of the planetary or differential gear, comprising a friction disk rotatable about a friction disk axis, with the friction disk axis being arranged normally to the rotational axes of the friction wheels and setting up a plane with the same, with the friction disk being displaceably mounted in the plane parallel to the rotational axis of the friction wheels, and with the friction wheels having the same diameter and being capable of rolling off on the friction disk.

A friction gear with a differential and planetary gear is known from EP 0 009 343 A1, comprising two friction wheels of the same diameter which roll off on a friction disk. The friction disk which is rotatable about a friction disk axis normally to the rotational axis of the friction wheels is arranged in a longitudinally displaceable manner parallel to the rotational axis of the friction wheels. By displacing the friction disk, the roll-off radius of the friction wheels on the friction disk will change and thereby the speed ratio between the first friction wheel and the second friction wheel. As a result, a continuously variable transmission can be realized between an input shaft and an output shaft. The friction disks respectively comprise one annular rolling surface for the friction wheels and are rotatably held about a non-rotatable shaft journal. The middle region of the friction disks is therefore respectively not rotatable. This leads to the consequence that the middle friction wheel will be blocked abruptly once this friction wheel—during a change of the travelling direction for example—comes into contact with the stationary shaft journal. As a result, an additional coupling for interrupting the power flow between the friction disk and the output shaft is required at least during a change in the travelling direction.

It is the object of the invention to avoid this disadvantage and to enable an interruption in the power flow during a change in the direction of rotation of the output shaft in a friction gear of the kind mentioned above in the simplest possible way.

This is achieved in accordance with the invention in such a way that the friction disk comprises in the region of the friction disk axis a recess or depression which is arranged concentrically in relation to the friction disk axis.

It is preferably provided that the diameter of the circular recess or depression corresponds at least to the rolling width of at least one friction wheel which is intersected in at least one operating position of the friction gear by the friction disk axis.

A change in the speed which offers the lowest possible wear and tear can be achieved when at least one friction wheel, as seen in a meridian section, comprises a convexly curved rolling-off region with a defined radius of curvature. It can be provided for power flow interruption in this respect that the recess or depression comprises a curved concave surface, with preferably the radius of curvature of the surface corresponding substantially to the radius of curvature of the friction wheel.

The diameter of the recess or depression will be kept as small as possible in order to enable jolt-free starting of the output shaft from the idle state. The radius in the region of the bottom part of the recess or depression and in the region of the transition to the flat rolling surface of the friction disk allows smooth acceleration from standstill.

In order to enable secure power flow interruption, it is provided that the recess or depression has a defined maximum depth which corresponds at least to the press-in depth of the preferably elastically arranged friction wheel.

The rolling surface of the friction disk is arranged to be substantially flat and enclosed in order to enable a constant change of the speed ratio between the input and output shafts.

At least two, preferably at least three, friction disks can be provided depending on the level of the maximally transmissible torque, which friction disks are respectively rotatable about a friction disk axis and whose friction disk axes arranged normally to the rotational axis of the friction wheels have a common point of intersection on the rotational axis of the friction wheels.

A simple change in the speed ratios can be achieved when the friction disk is rotatably mounted on a disk carrier which is displaceably mounted parallel to the rotational axis of the friction wheels.

The invention will be explained in closer detail below by reference to the drawings, wherein:

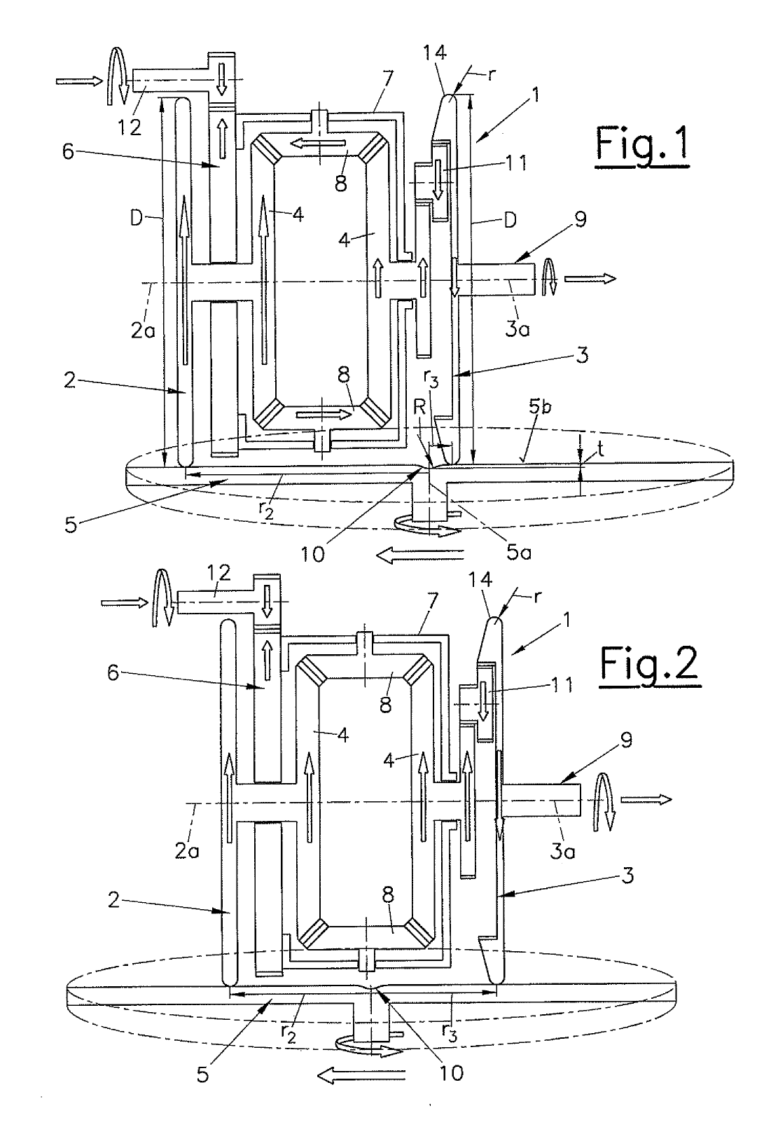

FIG. 1 shows a friction gear in accordance with the invention in a first operating position;

FIG. 2 shows the friction gear in a second operating position;

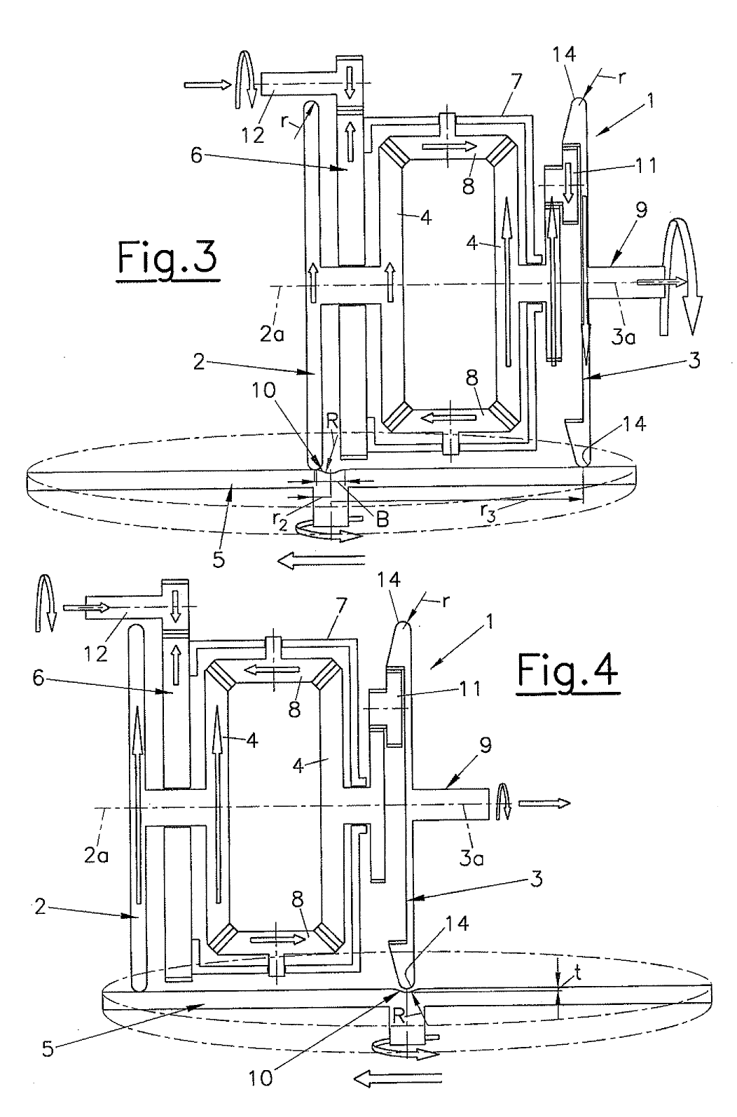

FIG. 3 shows the friction gear in a third operating position;

FIG. 4 shows the friction gear in a fourth operating position;

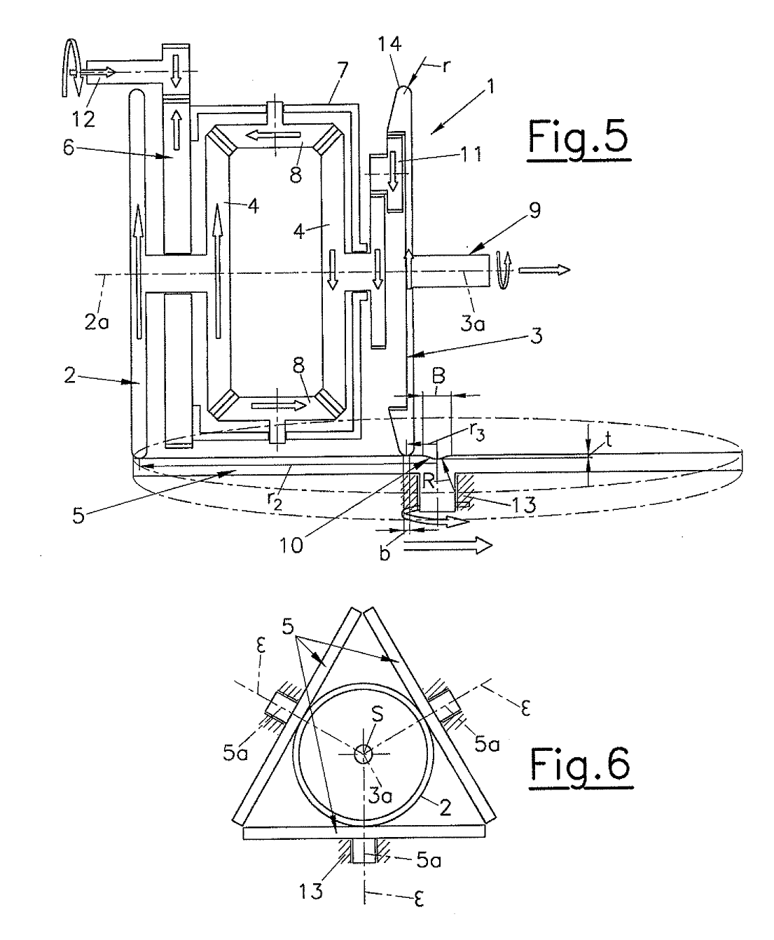

FIG. 5 shows the friction gear in a fifth operating position, and

FIG. 6 shows a front view of an embodiment of a friction gear in accordance with the invention.

The friction gear which is shown in FIGS. 1 to FIG. 5 and is mechanically adjustable in a continuously variable manner comprises a differential gear 1 and two friction wheels 2, 3, which are respectively connected with one friction wheel. The friction wheels 2, 3 whose rotational axes 2a, 3a are arranged to be axially in alignment and have the same diameter D are connected by means of frictional connection via the adjustable friction disk 5.

The introduction of torque occurs via the input shaft 12 on the ring gear 6 of the differential gear 1 which is connected with the differential housing 7, and said torque is distributed via the differential pinions 8 onto the shaft wheels 4. The distribution of the torque onto the shaft wheels 4 is controlled by the position of the friction disk 5 and the thereby resulting friction point radius r₂, r₃ of the friction wheels 2, 3 on the friction disk 5. The frictional connection for an idle position can be interrupted by a recess or depression 10 in the region of the friction disk axis 5a of the friction disk 5 arranged with a substantially flat rolling surface 5b. The gearwheel 11 is used for reversing the direction of rotation.

FIG. 1 shows the friction gear in a first operating position, in which there is a speed-decreasing ratio. The friction disk 5 has been displaced to such an extent to the left that the friction wheel 3 is disposed outside of the recess or depression 10 of the friction disk 5. This also leads to a frictional connection between the friction wheels 3 and the friction disk 5. The input speed of the ring gear 6 is distributed via the differential gear 1 onto the friction wheels 2, 3 at the ratio of the current friction point radius r₁ to r₂ on the friction disk 5 onto the shaft wheels 4. The friction wheel 3 and therefore the output shaft 9 rotate slower than the input shaft 12.

FIG. 2 shows a second operating position of the friction gear, in which the gear ratio between the speed of the input shaft 12 and the speed of the output shaft 9 corresponds approximately to 1:1. The friction disk 5 is displaced further to the left until the friction point diameter r₂, r₃ of the two friction wheels 2, 3 with the friction disk 5 have the same distance from the friction disk axis 5a. The input speed of the ring gear 6 is distributed via the differential gear 1 onto the friction wheels 2, 3 at the ratio of the current friction point radii r₂, r₃ on the friction disk 5. The friction wheels 3 and therefore the output shaft 9 rotate at a ratio of 1:1 to the input speed of the gear ring 6.

FIG. 3 shows the friction gear in the third operating position, in which there is a speed-increasing ratio. The friction disk 5 is displaced even further to the left. The input speed of the gear ring 6 is distributed via the differential gear 1 onto the friction wheels 2, 3 at the ratio of the current friction point radii r₂, r₃ on the friction disk 5. The friction wheel 3 and therefore the output shaft 9 rotate faster than the speed of the input shaft 12.

FIG. 4 shows the friction gear in a fourth operating position corresponding to the idle state. In the idle state, the friction disk 5 is set in such a way that the friction wheel 5 is intersected by the friction disk axis 5a and there is no frictional connection with the friction disk 5 as a result of the recess or depression 10 in the middle of the friction disk. As a result, the entire input speed of the gear ring 6 is guided into the friction wheel 2 and further onto the friction disk 5. The friction wheels 3 and therefore the output shaft 9 will stand still.

FIG. 5 shows the friction gear in a fifth operating position which corresponds to the reverse gear. The friction disk 5 has been displaced to such an extent to the right that the friction wheel 3 is disposed outside of the recess or depression 10 of the friction disk 5. As a result, there will also be a frictional connection between the friction wheel 3 and the friction disk 5. The input speed of the gear ring 6 will be distributed via the differential gear 1 onto the friction wheels 2, 3 at the ratio of the current friction point radii r₁, r₂ on the friction disk 5. The friction wheel 3 and therefore the output shaft 9 rotate slowly and in the opposite direction to the input speed and the input direction.

The depth t of the depression 10 corresponds at least to the press-in depth of the friction wheels 2, 3 which are made of elastic material. The width of the recess or depression 10 should correspond at least to the roll-off width b of the friction wheels 2, 3. In order to achieve the highest possible point-shaped contact area with low frictional losses between the friction wheels 2, 3 and the friction disk 5, each friction wheel 2, 3 in the rolling area 14 is arranged in a concave curved way as seen in a meridian section and comprises a defined radius of curvature r in the rolling area 14. In the embodiment, the surface of the recess or depression 10 is arranged with a respectively concave radius of curvature 3 which corresponds at least to the radius of curvature r of the friction wheels 2, 3 in the rolling area 14. As a result, a complete interruption of the power flow between the input shaft 12 and the output shaft 9 is achieved on the one hand and a smooth starting process is enabled on the other hand.

In order to enable a jolt-free and smooth starting of the output shaft 9 from the idle state, the width B of the recess or depression 10 should be kept as small as possible.

In order to enable the transmission of high torques between the input shaft 12 and the output shaft 9, it is also possible to provide several friction disks 5. FIG. 6 shows an embodiment of a friction gear with three friction disks 5, the friction disk axes 5a of which are arranged normally to the rotational axes 2a, 3a of the friction wheels 2, 3, with the friction disk axes 5a respectively opening up a plane E with the rotational axes 2a and 3a of the friction wheels 2, 3. The friction disk axes 5a intersect in a common point S in the region of the rotational axes 2a and 3a. All friction disks 5 are mounted rotatably in a common friction disk carrier 13 which is displaceable parallel to the rotational axes 2a and 3a of the friction gear.

The described friction gear enables a continuously variable speed adjustment in a simple way, wherein high ratio ranges of the transmission can be realized. As a result of the recess or depression 10 in the region of the center of the friction disk, an idle position can be enabled, wherein a reversal in the direction of rotation of the output shaft 9 which is switchable during operation and a decoupling of the output shaft from the friction disk 5 can be realized without using a separate coupling. Only one single adjusting element is required for changing the speed ratio between the input shaft 12 in the output shaft 9 and for reversing the direction of rotation.

I claim:

1. A friction gear for the continuously variable speed control of the speed of an output shaft which is driven by a driving input shaft, with a planetary gear or differential gear being arranged between an input and output shaft, with a first component of the planetary or differential gear being connected with a first friction wheel and the second component of the planetary or differential gear being connected with a second friction wheel disposed on the same rotational axis in respect of the first friction wheel, with the second friction wheel being drivingly connected with the output shaft and with the input shaft being drivingly connected with a third component of the planetary or differential gear, comprising a friction disk rotatable about a friction disk axis, with the friction disk axis being arranged normally to rotational axes of the friction wheels and opening up a plane therewith, with the friction disk being displaceably mounted in the plane parallel to the rotational axis of the friction wheels, and with the friction wheels having the same diameter and being capable of rolling off on the friction disk, wherein the friction disk comprises in the region of the friction disk axis a recess or depression which is arranged concentrically in relation to the friction disk axis.

2. The friction gear according to claim 1, wherein the diameter of the circular recess or depression corresponds at least to a rolling width of at least one friction wheel which is intersected by the friction disk axis in at least one operating position of the friction gear.

3. The friction gear according to claim 1, wherein at least one friction wheel, as seen in a meridian section, comprises a convexly curved rolling-off region with a defined radius of curvature.

4. The friction gear according to claim 3, wherein the recess or depression has a curved concave surface.

5. The friction gear according to claim 4, wherein a radius of curvature of the surface corresponds substantially to a radius of curvature of the friction wheel in the rolling-off area.

6. The friction gear according to claim 1, wherein the recess or depression has a defined maximum depth which corresponds at least to a press-in depth of the friction wheel.

7. The friction gear according to claim 1, wherein the friction disk has a substantially flat enclosed rolling area.

8. The friction gear according to claim 1, wherein the friction disk is rotatably mounted on a disk carrier which is displaceably held parallel to the rotational axis of the friction wheels.

9. The friction gear according to claim 1, wherein at least two friction disks are provided which are respectively rotatable about a friction disk axis and whose friction disk axes arranged normally to the rotational axis of the friction wheels have a common point of intersection on the rotational axis of the friction wheels.

10. The friction gear according to claim 1, wherein at least three friction disks are provided which are respectively rotatable about a friction disk axis and whose friction disk axes arranged normally to the rotational axis of the friction wheels have a common point of intersection on the rotational axis of the friction wheels.
